(19) United States
(12) Patent Application Publication
(10) Pub. No.: US 2005/0008858 A1
(43) Pub. Date: Jan. 13, 2005

(54) Water soluble luminescent nanoparticles

(76) Inventors: Gareth Wakefield, Oxford (GB); Mark Green, Oxford (GB)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/494,126

(22) PCT Filed: Nov. 1, 2002
(86) PCT No.: PCT/GB02/04968

(30) Foreign Application Priority Data
Nov. 1, 2001 (GB) 0126284.9

(51) Int. Cl. B32B 5/16; C01F 17/00; C09K 11/08

(52) U.S. Cl. 428/402; 423/263; 252/301.4 R; 252/301.5; 252/301.4 F; 252/301.6 F; 252/301.6 R

(57) ABSTRACT

A particle of a compound of the formula: Xₐ(YO_{b})_{c} wherein X is a rare earth metal or a metal of Group IIA, IIB, IVB or VB of the Periodic Table, or a mixture of two or more thereof, Y is a metal which forms an anion with oxygen, or a mixture of two or more thereof, and a, b and c are such that the compound is stoichiometric, the particle having a size less than 100 nm is disclosed. It can be used in, for example, security marking and biotagging.

This invention relates to the preparation of water-soluble quantum dots or nanoparticles which are particularly useful in biological tagging and security tagging.

The use of common organic dyes for tagging presents many problems, in particular due to photobleaching and because the narrow absorption bands make it difficult to excite different colours at once. Dye emission can also be broad, making multicolour imaging difficult. Previous attempts to utilise luminescent quantum dots for tagging applications have more recently been based principally on semiconductors, with luminescence of various colours being generated by transitions across the quantum confined semiconductor band gap. The size of the nanoparticles governs the wavelength of the emission. This approach has a number of significant drawbacks:

(i) Semiconductors with suitable bulk band gaps are based on materials such as group III/V or group II/VI materials. Typically, CdSe or CdS are used. These materials are toxic, and synthesis is generally carried out in organic solvents. Therefore, phase transfer to water is required after they have been prepared. This is technologically difficult to carry out while maintaining luminescence efficiency. Quantum dots which can be formed in water remove a significant barrier to synthesis.

(ii) If semiconductors are used then size selection must be used to separate material of different emission wavelengths. This leads to a substantial loss of material for a single synthesis run while requiring an additional step which involves the use of specialist equipment.

(iii) Typical semiconductor materials are toxic, and their precursors may be highly toxic. Also they are frequently air/moisture sensitive.

(iv) To make highly luminescent particles requires a further shell of semiconductor of a wider bandgap and often a further shell of silica.

There is therefore a need for water-soluble quantum dot materials (generally ≦100 nm) which are non-toxic and which can be prepared efficiently without the need for specialist apparatus.

It has been found that these needs can be met by certain phosphors which have the advantage that they are intrinsically luminescent, non-toxic and can be synthesised by a route which requires no specialist apparatus.

According to the present invention there is provided a particle of a compound of the formula:
Xₐ(YO_{b})_{c}
wherein X is a rare earth metal or a metal of group II A, IIB, IVB or VB the Periodic Table, or a mixture of two or more thereof, Y is a metal which forms an anion with oxygen, or a mixture of two or more thereof, and a, b and c are such that the compound is stoichiometric, the particle having a size less than 100 nm.

The use of rare earths in this way is particularly surprising since it is known that they are susceptible to concentration quenching i.e. as their concentration increases their emission gets quenched by adjacent rare earth ions.

Typical metals for X include rare earth metals such as Eu, Dy, Th, Ce, Sm, Er, Th, Gd and Pr, as well as Yb and Ho. Suitable metals of group II A and B include magnesium, calcium and zinc while metals of groups IVB and VB include bismuth tin and lead. In one embodiment the group IIA metal is not calcium and the compound is not CaWO₄.

The metals for Y are those which form an anion with oxygen so that they are in the form of metalates. Preferred metals for Y include tungsten, vanadium, molybdenum, niobium and tantalum.

The simplest compounds are generally those where a is I, b is I and c is 4 as in Eu(MoO₄) but other phases of such compounds exist, for example Eu₂(MoO₄)₃. The compounds can have more than two metals present. Thus the compound may be derived from more than one metal X and/or more than one metal Y. The use of mixtures such as mixed anions provides a combination of active centres excitable to optimise absorption characteristics beyond those obtainable for each anion independently. A specific example is where Y is a mixture of vanadium and tungsten. Such compounds typically respond to excitation wave lengths of the order of 320 nm. Mixed cations can be used to produce compounds where the distribution of luminescent ions is modified such that concentration quenching effects, for example, are reduced/minimised. A specific example is where X is a mixture of Gd and Eu. Thus the compound may be a mixed vanadate/tungstate salt of gadolinium and europium.

The particles of the present invention are quantum dots having a particle size not exceeding or less than 100 nm, typically not exceeding 50 nm, for example 1 to 50 nm. The particles can be formed without difficulty with a particle size less than or not exceeding 10 nm, for example 2 or 3 nm to 10 nm.

The particles of the present invention can be prepared by a process which comprises mixing an aqueous solution having a basic pH of a compound containing an anion of Y and a surfactant with is an organic acid or a Lewis base, with an aqueous solution of a compound containing the cation X.

Thus a water-soluble compound containing an anion of Y can be added to water, generally with stirring, and a suitable surfactant is added to it. The surfactant has the effect of passivating the surface, stopping particle growth and maintaining luminescence efficiency. It will be appreciated that particle growth will generally give rise to substantially crystalline particles. The pH is then generally increased, generally by addition of a base. The purpose of this is to maintain the correct anion/cation ratio in the precipitated materials. In general, the pH should be maintained at least 8 and typically 8 to 10, for example 8 to 9.

The material can then be precipitated by the addition of a solution of a water-soluble compound containing the cation, generally with stirring. Usually, the quantum dot material forms instantly and luminescence is clearly visible.

The water-soluble compound containing an anion of Y is typically an alkali metal salt such as a sodium salt e.g. sodium tungstate although ammonium salts such as 5(NH₄)₂O. 12WO₃5H₂O can also be used.

Surfactants which can be used are organic acids and Lewis bases which are generally polar.

For the ligand/surface active molecule to be effective it must be able to stick to the particle surface. Typically compounds which can achieve this include phosphines, phosphine oxides, thiols, amines, carboxylic acids, phosphates, such as sodium hexametaphosphate, which is preferred, sulfonic acids, sulfinic acids, phosphoric acids, phosphonic acids, phosphinic acids, crown ethers and mixtures of these. The compound used will, of course, depend on the nature of the particle as one skilled in the art will appreciate. For example it is believed that cerium attracts carboxylic acid groups. However tungstates and the like generally attract phosphate groups.

The ligand itself can be monodentate (i.e. with a single binding point, e.g. a trialkylphosphine oxide e.g. with a chain length of 4 to 20 carbon atoms), bidentate (e.g. dihydrolipoic or a dialkyl sulphosuccinate e.g. sodium dioctyl sulphosuccinate with a similar chain length to monodentate) or multi dentate (polymer/dendrimers with pendant side groups such as phosphines, phosphine oxides, thiols, amines, carboxylic acids, phosphates, sulfonic acids, sulfinic acids, phosphoric acids, phosphinic acids and mixtures of).

The ligand can also be polymeric such as vinyl pyrrolidone or a polymer possessing, preferably, a carboxylic acid and/or phosphonate group such as polymers derived from, for example, a vinyl carboxylic acid such as acrylic acid and/or a vinyl monomer possessing a group capable of binding to the particles such as vinyl phosphonic acid e.g. Albritech 30 which is a copolymer of acrylic acid and vinyl phosphonate.

The ligand should be water soluble. If necessary, therefore, the molecule may contain other groups which assist solubility such as hydroxy and deprotonated acid or protonated amine groups. Thus if a polymer is used it may have side chains that make the ligand water soluble, e.g. hydroxy groups, deprotonated acids or protonated amines.

Other water-soluble ligands which can be used include sugar molecules, including oligosaccharides, monosaccharides, and polysaccharides which are water-soluble and contain side groups for further biocoupling reactions such as hydroxy groups as well as amine phosphates, typically nucleoside phosphates such as adenosine and guanosine phosphates including ATP (adenosine 5′-triphosphate), ADP (adenosine diphosphate), AMP (adenosine monophosphate) and GMP (guanosine monophosphate). Cyclodextrins (cyclic oligosaccharides), functionalised with phosphines, phosphine oxides, thiols, amines, carboxylic acids, phosphates, sulfonic acids, sulfinic acids, phosphoric acids, phosphinic acids and mixtures of can also be used.

It is known that certain metals bind well to certain groups. Accordingly a molecule containing such a group will bind to that metal via this group, leaving the other group (or groups) free for a biocoupling reaction. Thus in many cases a thiocarboxylic acid will coat the particle with the carboxylic grouping on the surface as the thiol group has a stronger affinity for the metal(s) in the particle. Chemical and spectroscopic tests can be made, if necessary, to determine how the capping agent is oriented.

Generally, the reactants should be used in approximately stoichiometric amounts using a roughly equimolar amount of surfactant and the water-soluble compound containing Y, although, in general, the relative molar amounts are from 0.3 to 2. Preferably the molar ratio of surfactant to salt is about 1:1 to 2:1. Provided sufficient surfactant is present it can help redispersion of the surfactant once the particles have been formed. The concentrations of the ingredients in the aqueous solutions are not particularly critical but generally do not exceed about 0.1M as if the concentration is to 0 high flocculation of the particles may occur. Typical concentrations are from 0.005 to 0.1M, i.e. 0.01 to 0.05M such as about 0.2M.

Suitable materials which can be used to adjust the pH include alkalis such as sodium hydroxide, potassium hydroxide and ammonium hydroxide.

The ions of X are introduced as a water-soluble salt of X, preferably a halide and, in particular, a chloride.

The particles can be obtained as a powder by drying the precipitate which is formed, for example in a rotary evaporator. Alternatively, the particles can be precipitated with a non-aqueous solvent, which is miscible with water. Suitable such solvents include polar organic solvents such as aliphatic or aromatic alcohols, especially aliphatic alcohols having 2 to 6, for example 3 or 4, carbon atoms such as propanol. Other suitable solvents include ethers and light petroleum. A non-polar solvent can be used with the polar solvent such as an aliphatic ketone e.g. acetone. A mixture of propanol and acetone can be suitable. A powder can be obtained by, for example, centrifuging.

The process can generally be carried out at room temperature, and typically at 0° to 40° C., for example about 20° C. The use of elevated temperature tends to result in the luminescence of the particles decreasing on standing; this may well be associated with the fact that as the temperature rises, the surfactant has lower binding strength.

The process can readily be carried out in air. In other words no special conditions are needed in this respect.

The particles of the present invention find particular utility in the fields of security marking and biological tagging.

For security marking, the quantum dot material is typically formed into an ink which may be either aqueous or non-aqueous. If they are aqueous then it is necessary for the surfactant to provide hydrophilic groups on the surface of the coating. These include —OH, —COOH and —N⁺ (amino or amido) groups. Typical ink formulations involve a binder. Suitable binders include polymers and resins such as carboxylated acrylic resins and ethylene/vinylester copolymers e.g. ethylene/vinylacetate copolymers e.g. containing about 40% vinylacetate by weight. Such inks can be used to print a luminescent security feature on any document or object. It is a particular feature of the particles of the present invention that their small size alters the emission profile of the luminescent centre from that of bulk material such that unique optical spectra are produced. This is a particular security feature since it makes it much more difficult for the counterfeiter to establish what the luminescent material is.

If the particles are to be used for biological tagging it is necessary that the particles present a reactive grouping on their surface which is capable of coupling with a suitable biological molecule. Typical surface groups which can be used for this purpose include —SH, —COOH and —N⁺ (amino or amido) as well as hydroxy groups. These groups may be at terminal points in the molecule, or as a side chain, and there can be more than one. These groups can be provided by selecting a surfactant which is capable of binding to the surface of the particles while at the same time providing the appropriate reactive group on the surface. In this connection reference should be made to our British application No. 0126283.1 (N83808). This application describes a process for preparing water soluble particles of a luminescent material which is a rare earth material, a doped compound semi-conductor or a doped inorganic compound which comprises coating particles of said luminescent material, either during production of the particles, or subsequently, with an organic acid or Lewis base such that the surface of the coating possesses one or more reactive groups.

In order to bind the particle to the moiety to be tagged use is made of a binding interaction between the moiety and a molecule attached to the particle involving a ligated binding pair. Typically such an interaction is a high affinity non-covalent coupling interaction between a moiety and a molecule able to bind to each other in physiological and/or cellular conditions. The binding may be reversible or non-reversible binding.

In one embodiment the moiety itself is the substance which it is desired to tag, and in this case the moiety will be in a non-modified form, i.e. in its naturally occurring form. In other embodiments the moiety is attached to the substance which it is desired to tag.

One or both of the moiety and molecule on the particle may be a protein or polynucleotide. Typically one or both of the moiety and molecule are naturally occurring substances, such as substances found in living organisms, for example prokaryotes and/or eukaryotes. In one embodiment the moiety and molecule are substances which may bind each other when present in their natural locations, such as a receptor ligand pair.

A wide range of moieties can be tagged in this way, for example any cellular component, for example membrane-bound, in the cytoplasm, either extra-cellular or intra-cellular. Moieties which move from one cellular location to another are particularly useful. The moieties can be present within an organelle, for example in the mitochondria or nucleus. They are typically proteins, polynucleotides, carbohydrates or lipids.

Examples of suitable ligand receptor binding pairs include:
transforming growth factor (TGF) and transforming growth factor receptor (TGFR) or EGF Receptor (EGFR);
epidermal growth factor (EGF) and EGFR;
tumor necrosis factor-.alpha. (TNF-.alpha.) and tumor necrosis factor-receptor (TNFR);
interferon and interferon receptor;
platelet derived growth factor (PDGF) and PDGF receptor;
transferrin and transferrin receptor;
avidin and biotin or antibiotin;
antibody and antigen pairs,
interleukin and interleukin receptor (including types 3, 4 and 5);
granulocyte-macrophage colony stimulating factor (GMCSF) and G,4CSF receptor;
macrophage colony stimulating factor (MCSF) and MCSF receptor; and
granulocyte colony stimulating factor (G-CSF) and C—CSF receptor.

When the moiety is any of the first mentioned substances in the above pairs then the molecule is generally the second mentioned substance and conversely when the molecule is any of the first mentioned substances then the moiety is generally the second mentioned substance. In the case of the antibody/antigen pair the antigen may be a protein or non-protein antigen. The antigen may be digoxigenin or phosphotyrosine.

As mentioned above both the molecule and moiety may be polynucleotides. In this case typically the polynucleotides are single stranded and able to bind to each other by Watson-Crick base pairing, i.e. they are partially or wholly complementary.

It will be appreciated that the reactive groups on the surface of the particle are selected such that one member of the pairs will react with the particle, either directly or with the aid of a crosslinking agent. These are standard reactions well known to those skilled in the art. For example, bovine serum albumin can be tagged with amino acid-coated phosphors using glutaric dialdehyde.

The following Examples further illustrate the present invention.

### EXAMPLE 1

Europium Tungstate

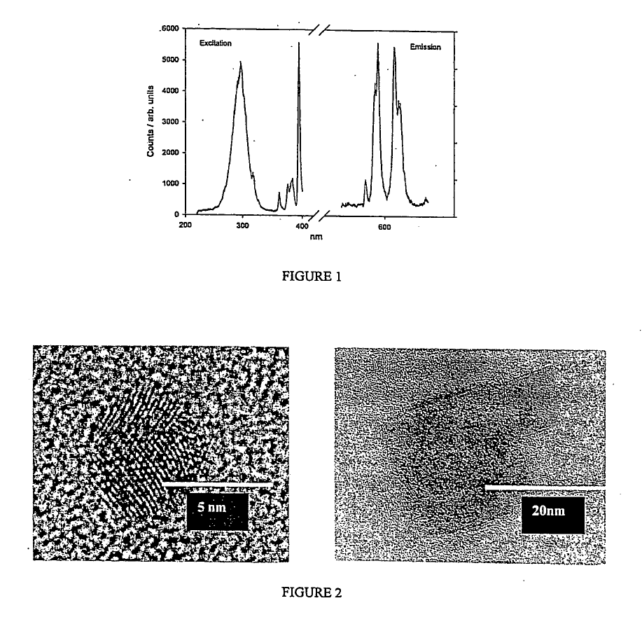

100 ml of 0.02M NaWO₄ in water and 100 ml of 0.02M Na(PO₃)₆ surfactant in water are mixed together and stirred for 10 minutes. The pH is adjusted to >8 by dropwise addition of 0.1M NaOH aqueous solution. After the pH adjustment, a 100 ml aqueous solution of 0.02 EuCl₃ is added under vigorous stirring. An immediate precipitation is observed; the material is quickly redispersed in the water. Under UV illumination the material emits bright red luminescence. The excitation and emission spectra are shown in FIG. 1. The broad excitation peak at 300 nm is due to transitions to the WO₄ centre and the sharp line at 395 nm is due to 4f→4fEu³⁺ transitions. The output consists of two peaks around 600 nm. In bulk Eu³⁺ containing compounds the peak at 611 nm is generally significantly stronger than the 590 nm peak. The output spectrum from the quantum materials is therefore considerably different.

This unusual output spectrum provides a special feature for security marking. In FIG. 2 electron micrographs of typical europium tungstate particles are shown.

### EXAMPLE 2

Terbium Tungstate

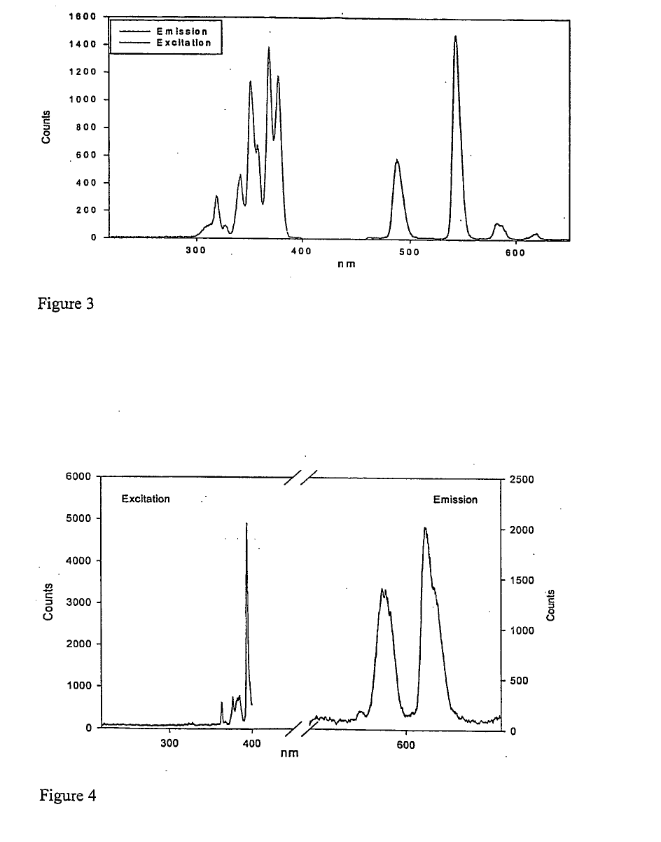

100 ml of 0.02M NaWO₄ is added to 100 ml of (NaPO₃)₆ and mixed for 10 minutes. The pH is adjusted to >8 by addition of 0.1M NaOH. To this is added 0.02M TbCl₃. The material is dried and redispersed. The optical spectrum of the nanoparticles is shown in FIG. 3.

### EXAMPLE 3

Europium Molybdenate

100 ml of 0.02M Na₂MoO₄ is added to 100 ml of 0.02M (NaPO₃)₆ and mixed for 10 minutes. The pH is adjusted to >8 by addition of 0.1M NaOH. To this is added 0.02M EuCl₃. The material is dried and redispersed. The optical spectrum of the nanoparticles is shown in FIG. 4.

A comparison of FIG. 4 and FIG. 1 shows the effect of substituting tungstate for molybdenate. The ratio of the two emission peaks has changed, with the 620 nm peak having a higher intensity relative to the 580 nm peak in the molybdenate. In the excitation spectrum the broad absorption band at 300 nm in the tungstate material has disappeared in the molybdenate.

### EXAMPLE 4

Gd_{13.5}EU_{6.5}(VO₄)_{26.7}(WO₃)_{13.3}
This was obtained using the following outline procedure:
1) 0.0613 g NaVO₄+0.055 g NaWO₃ are added to 4.5 ml water with 0.5 ml methanol added
2) 0.186 g GdCl₃ in 5 ml H₂O and 0.214 g EuNO₃ in 5 ml H₂O solutions are synthesised
3) 13.5 ml of GdCl₃ soln+6.5 ml of EuNO₃ solution+40 ml of the VO₄/WO₄ solution forms the material.

1. A particle of a compound of the formula:
Xₐ(YO_{b})_{c}
wherein x is a rare earth metal or a metal of group IIA, IIB, IVB or VB of the Periodic Table, or a mixture of two or more thereof, Y is a metal which forms an anion with oxygen, or a mixture of two or more thereof, and a, b and c are such that the compound is stoichiometric, the particle having a size less than 100 nm.

2. A particle according to claim 1 wherein X is Eu, Dy, Tb, Ce, Sm, Er, Gd, Th or Pr.

3. A particle according to claim 1 wherein X is magnesium, calcium, zinc, bismuth, tin or lead.

4. A particle according to claim 1 wherein Y is tungsten, vanadium, molybdenum, niobium or tantalum.

5. A particle according to claim 4 wherein Y is tungsten.

6. A particle according to claim 1 which has a size from 1 to 50 nm.

7. A particle according to claim 6 which has a size from 2 nm to 10 nm.

8. A particle according to claim 1 of europium tungstate, terbium tungstate, europium molybdenate, or a mixed vanadate/tungstate salt of gadolinium and europium.

9. A particle according to claim 1 which is coated with an organic acid or Lewis base.

10. A particle according to claim 9 which is coated with a Lewis base.

11. A particle according to claim 10 which is coated with a phosphate.

12. A particle according to claim 11 which is coated with sodium hexametaphosphate.

13. A particle according to claim 1 which is substantially crystalline.

14. A process for preparing a particle of a compound of the formula: Xₐ(YO_{b})_{c} wherein X is a rare earth metal or a metal of Group IIA, IIB, IVB or VB of the Periodic Table, or a mixture of two or more thereof, Y is a metal which forms an anion with oxygen, or a mixture of two or more thereof, and a, b and c are such that the compound is stoichiometric, the particle having a size less than 100 nm which comprises mixing an aqueous solution having a basic pH of a compound containing an anion of Y and a surfactant which is an organic acid of Lewis base, with an aqueous solution of a compound containing the cation X.

15. A process according to claim 14 wherein a water soluble compound containing an anion of Y is added to water, the surfactant is added to it, the pH is increased, if desired, and a solution of a water soluble compound containing the cation X is added.

16. A process according to claim 15 wherein the pH is adjusted to at least 8.

17. A process according to claim 14 wherein the cation Y is added as an alkali metal salt.

18. A process according to claim 14 wherein the water soluble salt of X is a halide.

19. A process according to claim 14 wherein the surfactant is a phosphate, polyvinylpyrrolidone or an vinyl carboxylic polymer.

20. A process according to claim 19 wherein the surfactant is sodium hexa-meta-phosphate or a copolymer of acrylic acid and vinyl phosphonate

21. A process according claim 14 wherein the particles are precipitated by the addition of a non-aqueous solvent.

22. A process according to claim 14 wherein the surfactant is such as will provide a surface reactive group.

23. A process according to claim 22 wherein the group is —OH, —SH, —COOH or —N⁺.

24. (Canceled).

25. A particle prepared by a process as claimed in claim 14.

26. A security marking ink which comprises a particle as claimed in claim 1 together with an aqueous or non-aqueous solvent and a binder.

27. An ink according to claim 26 wherein the binder is a carboxylated acrylic resin or an ethylene/vinyl ester copolymer.

28. A biotag which comprises a particle as claimed in claim 9 which is attached to one member of a ligand binding pair.

29. A biotag according to claim 28 wherein the binding pair is avidin and biotin or an antibody and an antigen.

30. (Canceled).

31. A process for tagging a moiety which comprises attaching a biotag as claimed in claim 28 either directly or after attaching to said moiety the other member of said ligand binding pair.

32. A process according to claim 31 wherein the biotag is produced with the aid of a cross linking agent.

33. (Canceled).
